(19) United States
(12) Patent Application Publication
(10) Pub. No.: US 2008/0094528 A1
(43) Pub. Date: Apr. 24, 2008

(54) LED illuminator filters

(75) Inventors: Michael G. Robinson, Boulder, CO (US); Gary D. Sharp, Boulder, CO (US); Miller H. Schuck, Erie, CO (US)

Correspondence Address: BAKER & MCKENZIE LLP;PATENT DEPARTMENT, 2001 ROSS AVENUE, SUITE 2300, DALLAS, TX, 75201, US

(73) Assignee: REAL D, Beverly Hills, CA (US)

(21) Appl. No.: 11/874,742

(22) Filed: Oct. 18, 2007

Related U.S. Application Data
(60) Provisional application No. 60/829,971, filed on Oct. 18, 2006.

(51) Int. Cl. G02F 1/13357; F21V 9/14; G02F 1/13

(52) U.S. Cl. 349/1; 349/69; 362/19

(57) ABSTRACT

Described are methods, systems and apparatuses that provide light sources to illuminate an LCD panel for a visual display. A light source includes a light emitting diode (LED) and a spectral filter. The spectral filter is operable to transmit a first set of spectral bands and block a second set of spectral bands from the LED. The spectral filter may be based on retarder stack technology or dichroic filter technology. Polarization and light recirculation techniques are disclosed and implementations into display systems described. These approaches are deemed useful for LED illuminated direct view color encoded stereoscopic systems based on LCD technology.

### CROSS REFERENCE TO RELATED APPLICATIONS

This application claims priority to U.S. provisional patent application No. 60/829,971, entitled “LED illuminator filters,” filed Oct. 18, 2006, which is incorporated by reference herein.

### TECHNICAL FIELD

Disclosed embodiments herein generally relate to optical illumination devices for visual display systems, and more in particular to light emitting diode (LED) optical illumination devices for use in liquid crystal (LC) display systems.

### BACKGROUND

Advances in active matrix liquid crystal display performance, particularly in television and gaming displays, have been achieved by new backlight technology and LCD display driving techniques. For instance, LEDs with improved RGB spectra have shown better gamut/efficiency over displays using conventional cold cathode fluorescent lamps (CCFL).

LEDs are predicted to replace CCFLs in mainstream LCD backlighting. Their temporal modulation capability and large color gamut create a more compelling visual experience, with a mercury-free illumination technology. Temporal modulation enables reduction in motion artifacts and also lends itself to filter-free displays, where primary colors illuminate the panel in a time-sequential color scenario. In some cases, more spectrally pure output is desired. For instance, this could be for very large three color gamut displays, whereby the primary colors are highly saturated.

LEDs have other applications in backlights that enable additional applications. A particularly relevant application involves modulation between non-overlapping spectra as a means of delivering stereo content. Optimized techniques involve providing left and right eye images with two distinct sets of red, green and blue primary wavelengths, which are decoded by matched filtering eyewear. Separating two sets of RGB LED spectra represents a demanding filtering operation. An example of using a pair of spectra synthesized from LED emitters in a backlight is described in commonly-assigned U.S. Pat. App. Pub. No. 2007/0188711 A1, entitled “Multi-functional active matrix liquid crystal displays” filed Feb. 9, 2007 (herein incorporated by reference).

However, one of the problems of using LEDs in backlights occurs due to wide manufacturing tolerances, leading to unacceptable output chrominance variation.

### SUMMARY

Addressing these issues and others, this patent disclosure describes various filtering techniques, apparatuses and their implementation in light sources for visual display systems.

In an embodiment, a light source includes a light emitting diode (LED) and a spectral filter. The spectral filter is operable to transmit a first set of spectral bands, and block a second set of spectral bands from the LED. The spectral filter may be based on retarder stack technology or dichroic filter technology.

In another embodiment using retarder stack technology, a light source includes an LED and a spectral filter operable to filter light output from the LED. The spectral filter may include an input polarizing element, an output polarizing element, and a retarder stack between the input polarizing element and the output polarizing element.

Numerous other embodiments and variations thereof are described with reference to the detailed description.

### BRIEF DESCRIPTION OF THE DRAWINGS

For a more complete understanding of the principles disclosed herein, and the advantages thereof, reference is now made to the following descriptions taken in conjunction with the accompanying drawings in which:

FIG. 1A is a graph showing intensity against wavelength for exemplary first and second sets of spectral bands, in accordance with the present disclosure;

FIG. 1B is a graph showing intensity against wavelength for filtered first and second sets of spectral bands, in accordance with the present disclosure;

FIG. 2 is a schematic diagram illustrating a cross-sectional view of a light source for a visual display, in accordance with the present disclosure;

FIG. 3 is a schematic diagram illustrating an embodiment of a light source for a visual display backlight, in accordance with the present disclosure;

FIG. 4A is a schematic diagram illustrating a second embodiment of a light source for a visual display backlight, in accordance with the present disclosure;

FIG. 4B is a schematic diagram illustrating a third embodiment of a light source for a visual display backlight;

FIGS. 5A and 5B are schematic diagrams illustrating a fourth embodiment of a light source for a visual display backlight, in accordance with the present disclosure;

FIG. 6 is a schematic diagram illustrating a fifth exemplary embodiment of a light source for a visual display backlight, in accordance with the present disclosure;

FIG. 7 is a schematic diagram of a sixth embodiment of a light source for a visual display backlight, in accordance with the present disclosure;

FIG. 8 is a schematic diagram of a seventh embodiment of a light source for a visual display backlight, in accordance with the present disclosure;

FIG. 9 is a schematic diagram of an eighth embodiment of a light source for a visual display backlight, in accordance with the present disclosure;

FIG. 10 is a schematic diagram of a ninth embodiment of a light source for a visual display backlight, in accordance with the present disclosure;

FIGS. 11A and 11B are schematic diagrams of a tenth embodiment of a light source for a visual display backlight, in accordance with the present disclosure;

FIG. 12A is a schematic diagram of an eleventh embodiment of a light source for a visual display backlight, in accordance with the present disclosure;

FIG. 12B is a schematic diagram of a twelfth embodiment of a light source for a visual display backlight, in accordance with the present disclosure;

FIG. 12C is a schematic diagram of a thirteenth embodiment of a light source for a visual display backlight, in accordance with the present disclosure;

FIG. 13 is a schematic diagram illustrating a system in which an array of light sources may be used to provide a backlight to illuminate an LCD panel, in accordance with the present disclosure;

FIG. 14 is a schematic diagram illustrating another system in which an array of light sources may be used to provide a backlight to illuminate an LCD panel, in accordance with the present disclosure;

FIGS. 15A and 15B are schematic diagrams illustrating spatially-separated filtering approaches incorporated into a scrolling LCD backlight, in accordance with the present disclosure; and

FIG. 16 illustrates a schematic diagram of an exemplary direct view LCD system in which alternate frames are illuminated by spectrally-separate filtered LED illuminators for stereoscopic viewing, in accordance with the present disclosure.

### DETAILED DESCRIPTION

Disclosed herein are systems, apparatuses, and methods that optically filter light emitting diodes (LEDs) for color-specific LCD illumination.

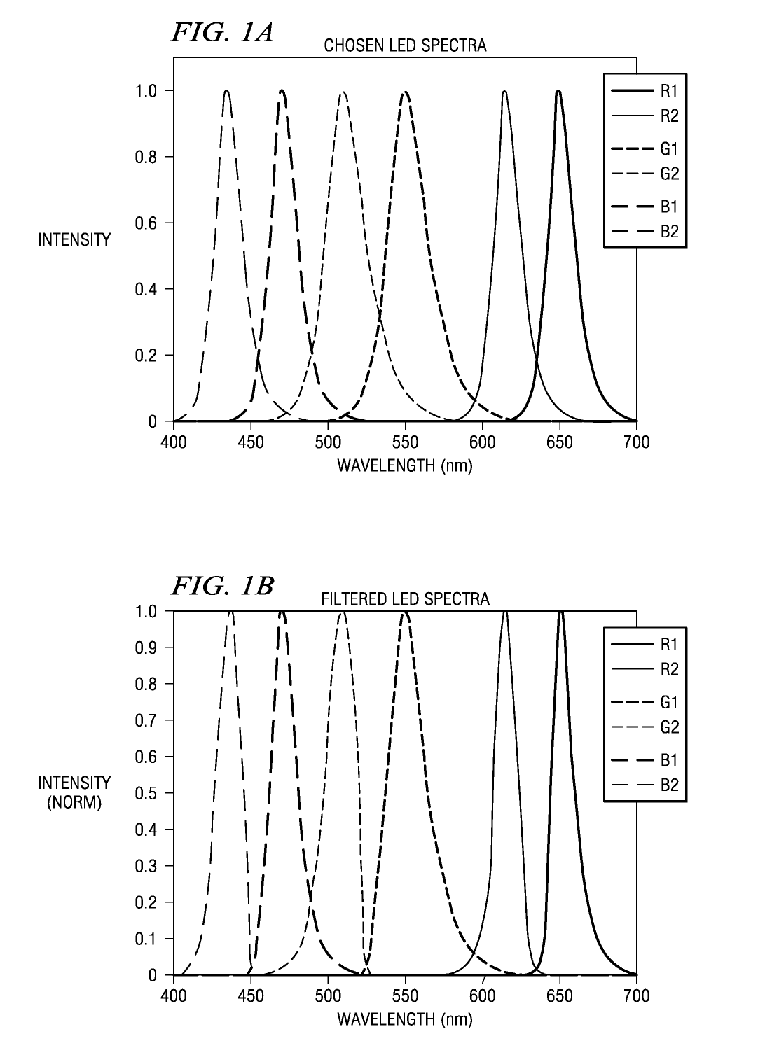

FIGS. 1A and 1B show typical LED emission spectra before and after desired filtering. It should be noted that the complete wavelength separation shown in FIGS. 1a and 1b might not be necessary for all systems. All embodiments can relate to LED packages with one or more colored emitters. These emitters can preferably be chosen to match the filtering pass bands but it is not required.

FIG. 1A is a graph showing intensity against wavelength for exemplary first and second sets of spectral bands. The LED spectra for the first set of spectral bands (R1, G1, B1) and second set of spectral bands (R2, G2, B2) are scaled to unity peak emission. The center wavelengths are selected so as to provide a high degree of spectral separation, thereby enabling modes of operation with little loss of light in the partitioning process.

FIG. 1B is a graph showing intensity against wavelength for filtered first and second sets of spectral bands. In this exemplary embodiment, the first set of spectral bands (R1, G1, B1) are substantially non-overlapping with the second set of spectral bands (R2, G2, B2). As used herein, the term “substantially non-overlapping” refers to most of the spectral emission being independent of an adjacent emission from another spectral emitter, such that cross talk between channel pairs R1/R2, G1/G2, and B1/B2, is preferably minimized. It should be appreciated by a person of ordinary skill in the art that using some off-the-shelf non-ideal spectral emitter technology, some spectral overlap may be present, for instance between channels B1 and G2, and channels G1 and R2, as shown by FIG. 1B. However, care should be taken in selection of spectral emitters and in the design of spectral filters to minimize such cross-talk between spectral emitter channel pairs. By careful selection of center wavelengths for spectral emitters, optimized color coordinates with enhanced gamut may be obtained. It will be appreciated that other types of spectral emitters such as lasers and super resonant LEDs have a narrower transmission range than typical LED structures, thus will be less likely to have spectral ranges that ‘overlap.’ With sufficient “non-overlapping” wavelength separation, the demands placed on the eyewear for efficient separation of imagery of first and second spectral light sets may be relaxed. This can be contrasted with conventional UHP lamp or CCFL spectra, which may use significant auxiliary filtering to accomplish similar spectral output, representing additional cost, and loss in light efficiency.

As shown in FIG. 1B, notches ideally exist both between short/long primary emission bands (i.e., B2/B1, G2/G1, R2/R1), as well as emission bands of the other primary colors. This separation is preferably maximized, with the understanding that the color coordinates should be acceptable and remain within a reasonable photopic sensitivity range (e.g., the short blue emission B22>430 nm; the long red emission R1<660 nm) for efficiency reasons. Such separation may be accomplished directly, through additional filtering that may be incorporated into the spectral emitter (i.e., LED) package to provide adequate color performance of the display. This may include filters that eliminate reject light, or filters incorporated into the emitting structure (e.g., Bragg reflectors) that redirect light back to the light generating medium. This filtering may have little influence on efficiency, provided that the main emission lobe is substantially captured, and that the tail of the emission is attenuated. The tail can be relatively broad, and while it contains relatively little power, it can have significant impact on ghost images when operating in stereo-mode. Such tail emission contributes directly to cross-talk and is independent of the performance of the eyewear. This is because it occurs at wavelengths at which the eyewear transmission should be high to ensure efficient transmission of the corresponding image.

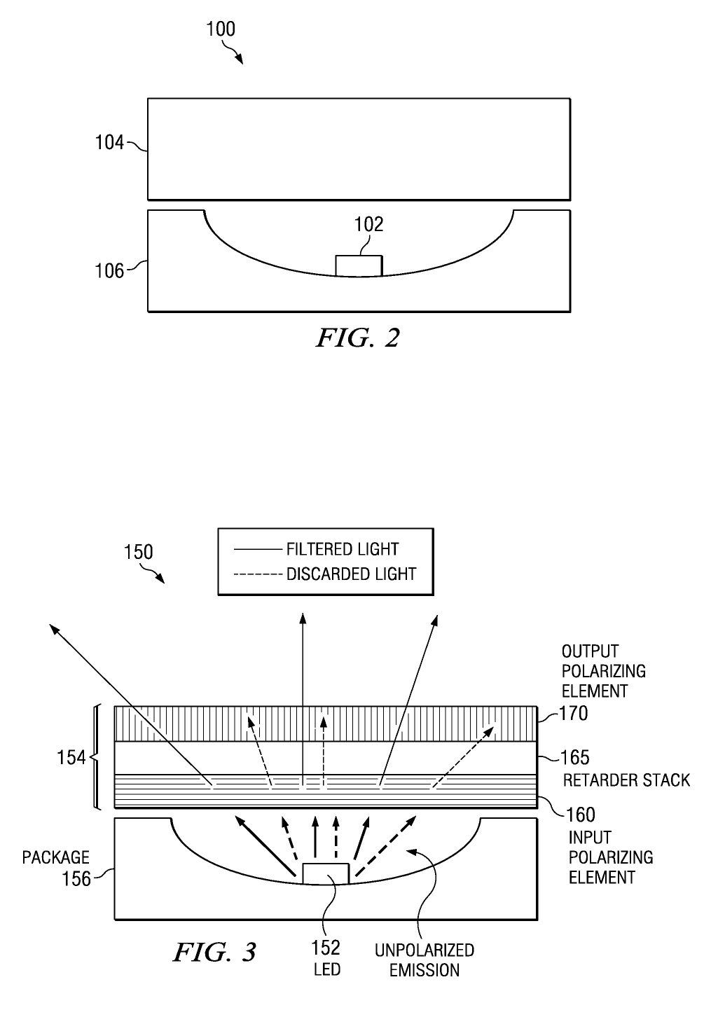

FIG. 2 illustrates a cross-sectional view of a light source 100 for a visual display. The light source 100 includes a light emitting diode (LED) 102 and a spectral filter 104 operable to transmit a first set of spectral bands, and block a second set of spectral bands. LED 102 is typically housed inside a light source package 106 with electrical connections such as pins and/or bond pads to attach the light source 100 component to a circuit board (not shown). Light source package 106 may also have high heat-conductive properties to dissipate and/or conduct heat away from LED 102. Packaging connector types are commonly known in the art and will not be described in detail because they are not germane to the disclosure. Spectral filter 104 may be coupled to the light source package 106 (e.g., using glue, chemical bonding, screws, compression, or any other known fixing technique). Alternatively, spectral filter 104 may be situated in close proximity to light source package 106 such that substantially all of the emitted light from LED 102 passes through the spectral filter 104 without any leakage of unfiltered light from the light source 100.

In an embodiment, the first set of spectral bands may include passbands for R1/G1/B1, and a second set of spectral bands may include stopbands for R2/G2/B2. In another embodiment, the first set of spectral bands may include stopbands for R1/G1/B1, and a second set of spectral bands may include passbands for R2/G2/B2. Generally, as discussed above, the R1/R2 pair, the G1/G2 pair, and the B1/B2 pair of pass/stopbands (or stop/passbands in some embodiments) are preferably substantially non-overlapping in frequency range.

In some embodiments, the spectral filter 104 may be based on color-selective retarder stack filter (RSF) technology (e.g., using ColorSelect® filters supplied by REAL D, Inc. of Boulder, Colo.). RSFs or ColorSelect filters utilize retarder stacks to rotate the state of polarization of a color band (e.g., color G) by 90°, while the complementary color band (e.g., color G′) retains the input state of polarization. RSFs or ColorSelect filters are disclosed in commonly-assigned U.S. Pat. Nos. 5,751,384 & 5,953,083 to Gary Sharp, and ROBINSON ET AL., POLARIZATION ENGINEERING FOR LCD PROJECTION 129-51 (2005), all of which are herein incorporated by reference. Generally, the retarder stack includes at least two retarder films. Stacked retarder films manipulate polarization such that precise filtering can be achieved when polarizers and analyzers are used. Further, an input polarizing element, the retarder stack, and an output polarizing element may be collectively designed to provide a Finite Infinite Response (FIR) filter, and thereby may be operable to generate at least N+1 spatially offset light pulses in response to a linearly polarized light impulse input. Thus, the FIR filter is operable to substantially filter at least one band of light. With appropriate biaxial films, these filters can be very angle tolerant and hence situated in close proximity to small LED emitters. These filters also dump unwanted light into the analyzer, avoiding spectral contamination through light leakage.

In other embodiments, the spectral filter 104 may be a dichroic filter. Various embodiments are disclosed below illustrating spectral filters of both varieties.

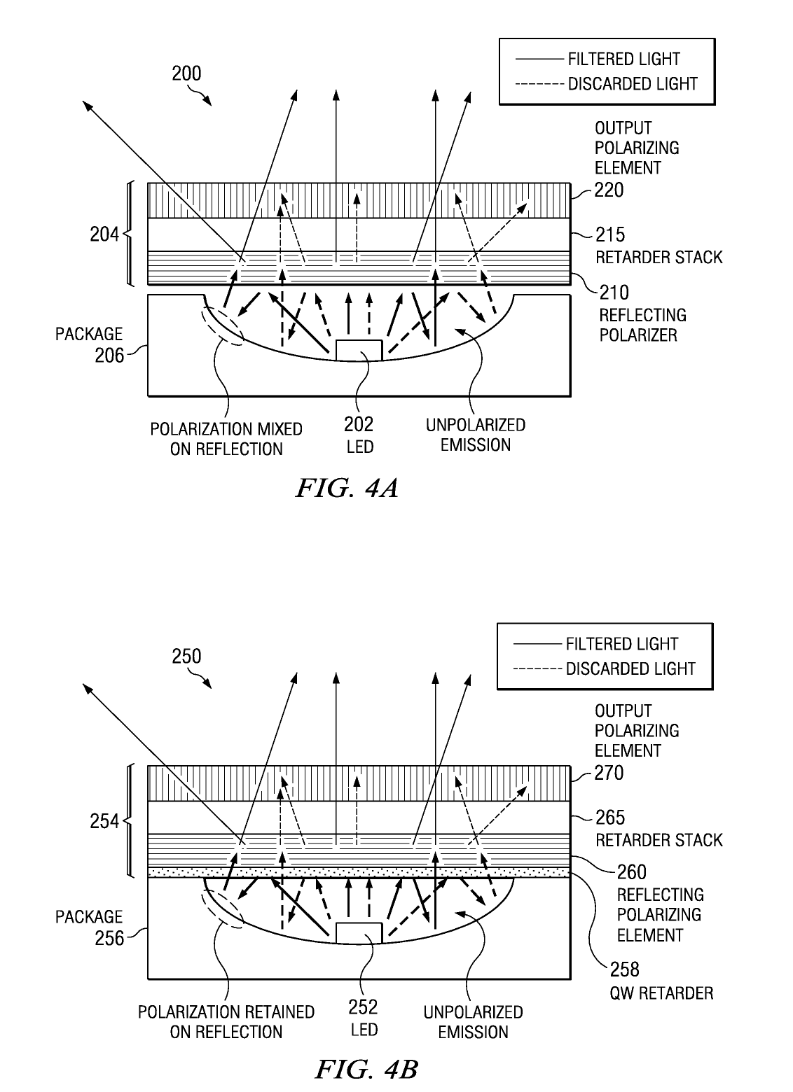

FIG. 3 is a schematic diagram illustrating an embodiment of a light source for a visual display backlight 150. Light source 150 includes a spectral filter 154 situated in close proximity to a light source package 156 that may contain one or more LEDs 152. In this embodiment, spectral filter 154 includes an input polarizing element 160 and an output polarizing element 170 located on the input and output sides a color-selective retarder stack filter 165.

In operation, emitted light from LED 152 is incident on an input polarizing element 160 before passing through the retarder stack filter 165. An output polarizing element 170 absorbs the light that is polarized parallel to the output polarizing element's 170 absorbing axis, allowing its complement to transmit. By absorbing the unwanted wavelengths in the output polarizing element 170, there is minimal possibility of color contamination through scattering. This approach also takes advantage of the tolerance of RSF 165 to incident angles, enabling it to be placed in close proximity to large angle LED emitter 152, reducing size and cost accordingly. As for all RSF-based embodiments, the exiting light is polarized and is likely transmitted with high transmission through an entrance polarizer attached to the LCD panel, assuming any intervening diffuser preserves polarization. In such a case, there would be little need for costly polarization recirculation film commonly used in present day commercial displays.

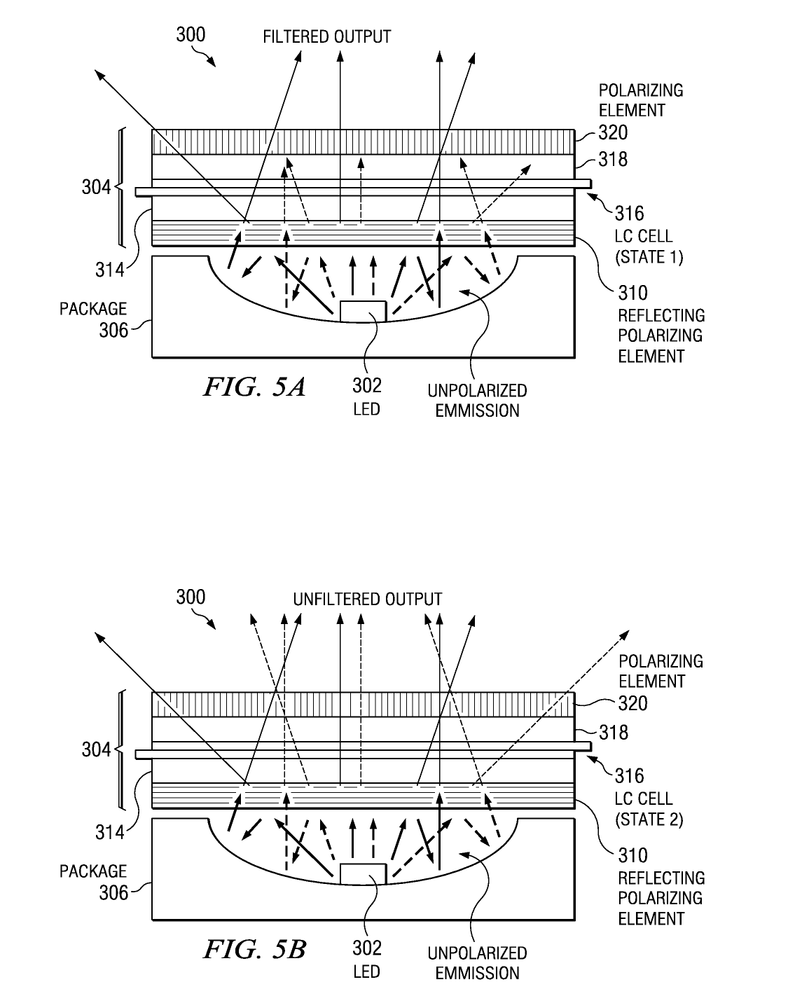

FIG. 4A is a schematic diagram illustrating a second embodiment of a light source 200 for a visual display backlight. It closely resembles that of FIG. 3, but has the input polarizing element 160 replaced by a reflecting polarizing element 210 such as Dual Brightness Enhancement Film (DBEF), provided by 3M, Inc., or a wire grid element as provided by Moxtek, Inc. Light incident on this reflecting polarizing element 210 with undesired polarization is then reflected instead of absorbed. On reflection, it can illuminate the internal surface of the light source package 206, which can be made to reflect and scramble polarization. Half of this second reflected light would then transmit through the reflecting polarizing element 210, adding to the overall output light exiting spectral filter 204. Further reflections would act to increase the net emission still further. In this manner, polarization recovery is implemented.

FIG. 4B is a schematic diagram illustrating a third embodiment of a light source 250 for a visual display backlight which introduces a quarter-wave plate (QWP) 258 in a light path ahead of the reflecting polarizing element 260. Here, reflected light from the reflecting polarizing element 260 is transformed in polarization. Should this light be reflected back without any further significant polarization change (as could be accomplished, for example, with a metalized package), it would be substantially transformed by the QWP 258 to the desired transmitted polarization state. Polarization recovery is thus achieved with a single bounce of light.

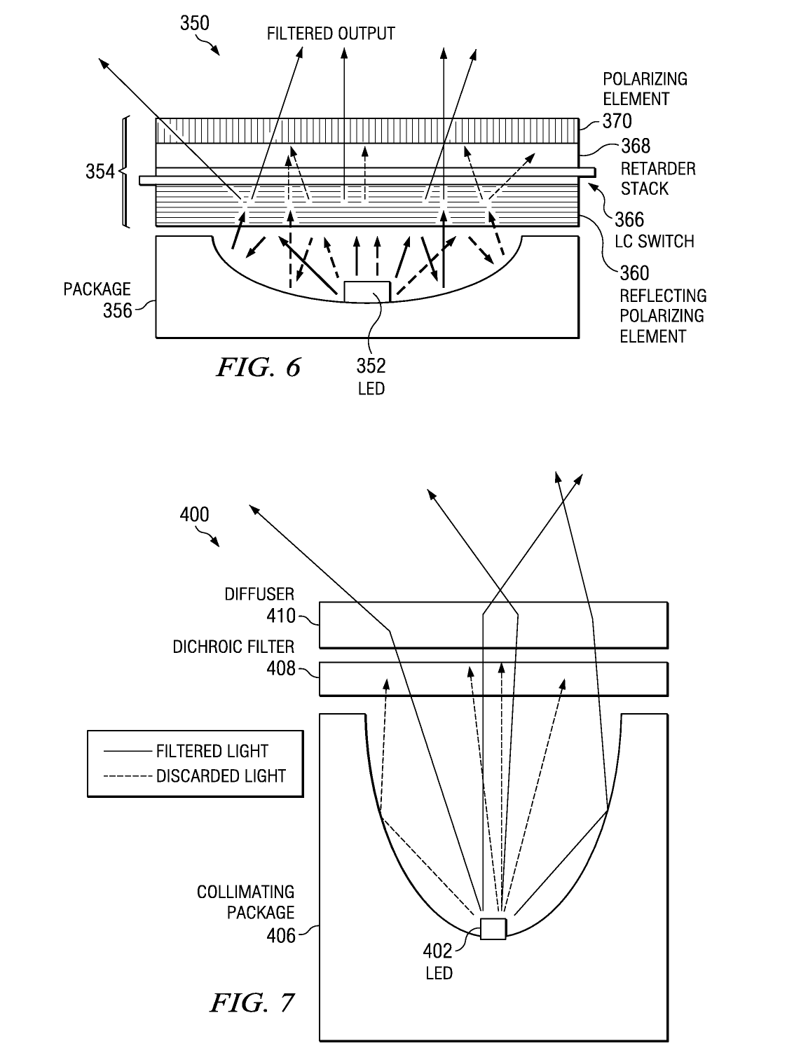

FIGS. 5A and 5B are schematic diagrams illustrating a fourth exemplary embodiment of a light source 300 for a visual display backlight. In this embodiment, a switching spectral filter 304 may be operable in a first state to allow a first and second set of spectral bands (providing an unfiltered output). In a second state, the switching spectral filter 304 may allow the first set of spectral bands to pass while blocking the second set of spectral bands (providing a filtered output).

The light source 300 includes an LED 302 and a switching spectral filter 304 operable to filter light output from LED 302. The switching spectral filter 304 may include input polarizing element 310, output polarizing element 320, first retarder stack 314 and second retarder stack 318, and LC switch 316, arranged as shown. LC switch 316 may be a zero twist 0° aligned LC cell, which is sandwiched between first and second retarder stacks 314, 318. The first retarder stack 314 may be a notch filter configured to allow a predetermined spectrum, such as R1G1B1, and block a second predetermined spectrum such as R2G2B2. The second retarder stack 318 has a retarder stack configuration that is the inverse of the first retarder stack 314. This embodiment may utilize an LC color modulation technique, as described in MICHAEL G. ROBINSON ET AL., POLARIZATION ENGINEERING FOR LCD PROJECTION 210-213 (2005), herein incorporated by reference.

In operation, switched spectral filter 304 operates on input light from LED 302, which is initially linearly polarized by polarizing element 310. The first retarder stack 314 creates a 45° oriented elliptical state of polarization for the spectral set to be switched (e.g., R2G2B2), while leaving the remaining spectrum unchanged. In a first state (e.g., the OFF-state), the LC switch 316 retains all polarization states such that the second, inverse retarder stack 318 returns all light to the original polarization (e.g., allowing R1G1B1 and R2G2B2 light to pass). In a second state (e.g., the ON-state) the LC switch 316 retards one polarization component (e.g., R2G2B2), such that the second retarder stack 318 creates the orthogonal polarization state. The LC switch 316 therefore transforms one spectral set only (e.g., R2G2B2), such that in the second state, the second polarizing 320 element blocks the orthogonal state, therefore blocking emission of a spectral set (e.g., R2G2B2 is blocked from the output).

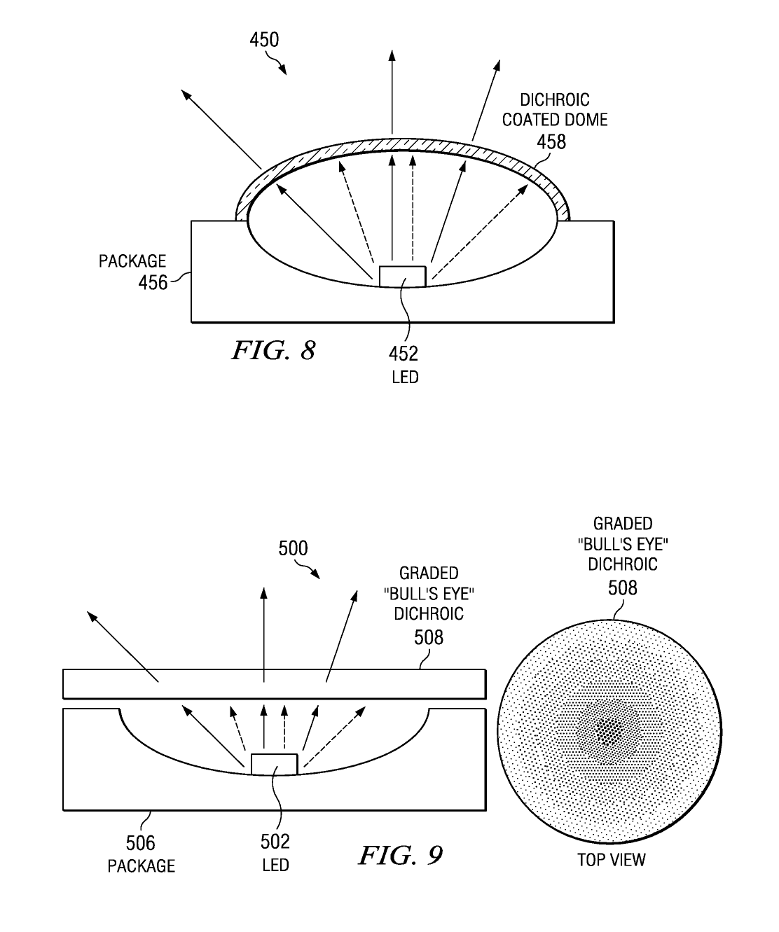

FIG. 6 is a schematic diagram illustrating a fifth exemplary embodiment of a light source 350 for a visual display backlight. In this fifth embodiment, a switching spectral filter 354 may be operable in a first state to allow a first set of spectral bands (e.g., R1G1B1) to pass and to block a second set of spectral bands (e.g., R2G2B2). Vice-versa, in a second state, the switching spectral filter may allow the second set of spectral bands to pass and to block the first set of spectral bands.

The light source 350 includes an LED 352 and a switching spectral filter 354 operable to selectively filter light output from LED 352. The switching spectral filter 354 may include input polarizing element 360, output polarizing element 370, retarder stack 368, and LC switch 366, arranged as shown. Retarder stack 368 is operable to rotate the state of polarization of a color band (e.g., R2G2B2) by 90°, while the complementary color band (e.g., R1G1B1) retains the input state of polarization. LC switch 366 may be, for example, a thick TN cell, having achromatic linear switching properties; or alternatively, LC switch 366 may use an FLC device, thus providing advantages of fast switching and being highly angular tolerant to off-axis light. Alternative embodiments may swap the positions of retarder stack 368 and LC switch 366.

In operation, switched spectral filter 354 operates on input light from LED 352, which is initially linearly polarized by polarizing element 360. In a first state (e.g., the OFF-state), the LC switch 366 retains all polarization states such that the retarder stack 368 outputs light of a first color band R1G1B1 orthogonally to light of a second color band R2G2B2. Depending on the orientation of the output polarizing element 370, only one of the first or second spectral set will be allowed to pass, while the other is blocked. In a second state (e.g., the ON-state) the LC switch 316 retards light, transforming the polarization of light passing through it by 90°. So, if in the first state, the first spectral set R1G1B1 was allowed to pass, then in the second state, the second spectral set R2G2B2 will instead be allowed to pass—and R1G1B1 will be blocked.

Some favored designs filter light well when the LC OFF-state is substantially normal to the substrates, since the LC switch 366 can then be more effectively compensated for off-axis light and provide a higher angle filtering function.

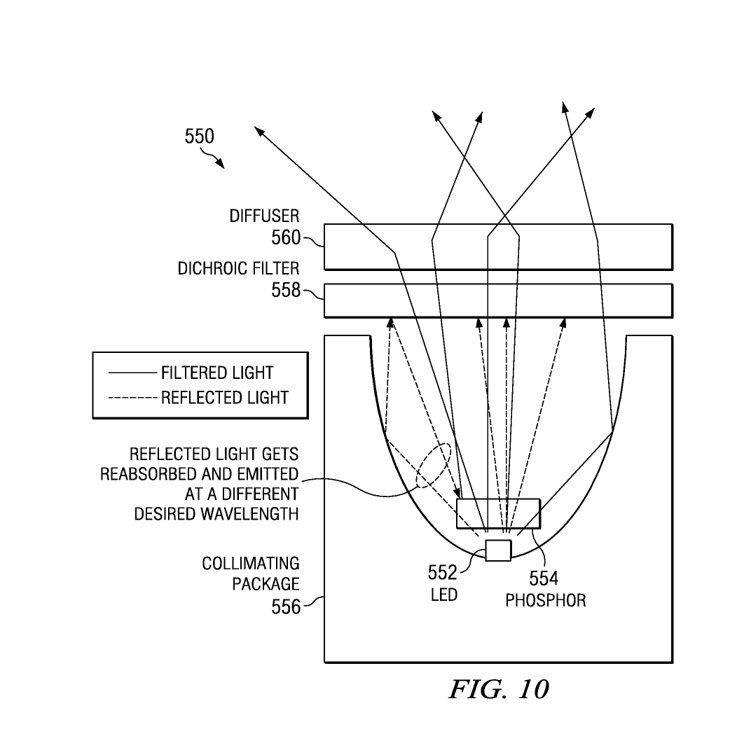

FIG. 7 is a schematic diagram of a sixth embodiment of a light source 400 for a visual display backlight that uses a dichroic filter. Light source 400 provides LED 402 emitting light generally in the direction of a dichroic filter 408 and diffuser 410. Generally, dichroic filters such as filter 408 comprise many (˜10-100) thin (˜1 um) layers of dielectric materials, typically coated onto a glass substrate. Interference between light that is reflected at the layer boundaries give rise to a defined transmission and its complementary reflection spectra. These so-called ‘dichroic’ filters reflect certain wavelengths while transmitting others. They can be designed using optimization algorithms and made with thin film deposition techniques such as evaporation or sputtering. Thus, dichroic filter 408 may be designed to allow a first spectral set to pass such as R1G1B1. In another embodiment, dichroic filter 408 may be designed to allow a second spectral set to pass such as R2G2B2.

Light source 400 may further include a light source package 406 that collimates light from LED 402 to reduce the light's incident angles on the dichroic filter 408 and hence would act to minimize undesired angular effects. Collimation may involve increasing the output aperture in accordance with the constant brightness condition, which in turn may call for a larger filter area than one placed directly above the LED 402. In this exemplary embodiment, unwanted light is reflected back into the package, where it is assumed it will be absorbed through multiple reflections. Further, in some embodiments, it may be desirable to introduce an absorbing means (such as a blackened region) to avoid excessive reflections and inevitable color contamination.

While often low cost, a disadvantage of dichroic filters is that they are typically very angularly dependent and by their very nature, require dumping of unwanted reflected light. Also, for very precise narrow band designs, many layers are required, adding to component cost. These issues might render dichroics more awkward to implement into LED backlights, where local filtering is desired.

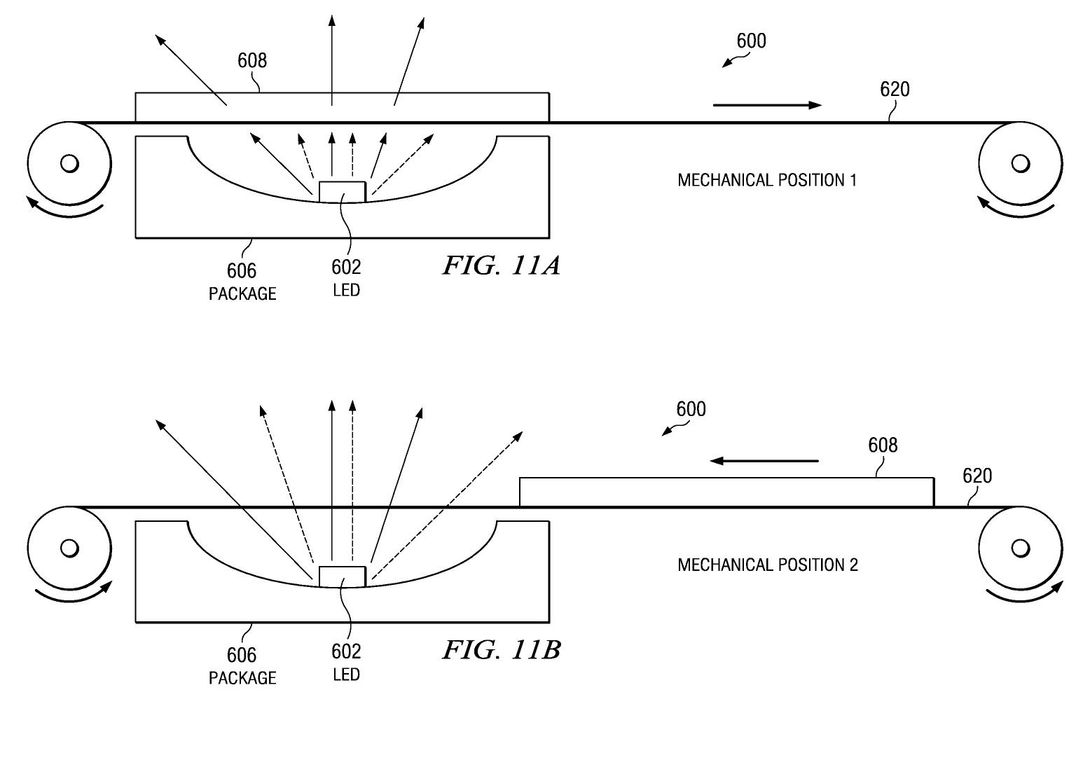

FIG. 8 is a schematic diagram of a seventh embodiment of a light source 450 for a visual display backlight that uses a dichroic filter. This exemplary embodiment uses a “dome” shaped substrate to improve the angular tolerance of the dichroic filter 458 and enable it to be situated closer to the LED 452, thus reducing size. Incident light is then geometrically more normally incident onto the coating, reducing undesired off-axis leakage.

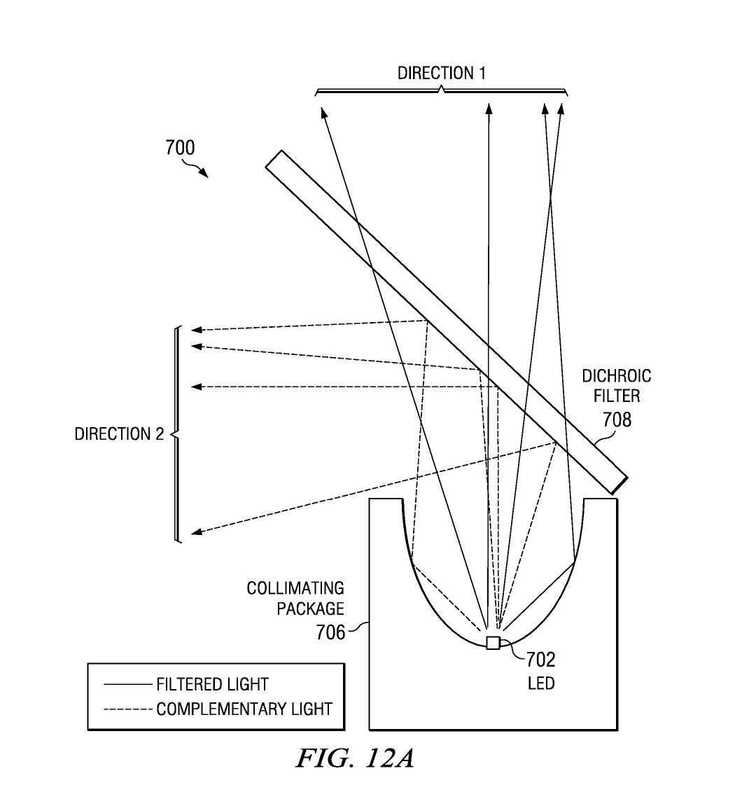

FIG. 9 is a schematic diagram of yet another embodiment of a light source 500 for a visual display backlight that uses a graded “bull's eye” dichroic filter 508. Here, dichroic filter 508 has a radial symmetric graded coating that has progressively thicker layers of dielectric materials as the radius from the center increases, to compensate for off-axis light (as shown by the top view).

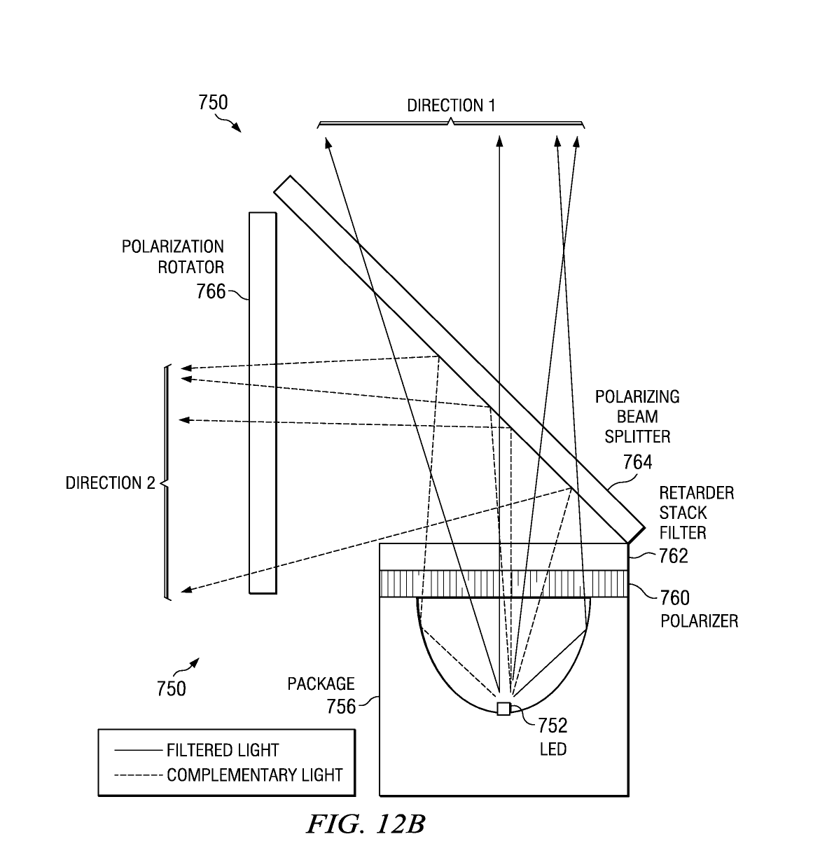

FIG. 10 is a schematic diagram of yet another embodiment of a light source 550 for a visual display backlight. The issue concerning unwanted reflected wavelengths of colors from a dichroic filter is used to advantage in the embodiment of FIG. 10. Here, an LED emitter 552 is made to produce emission from a phosphor 554 in a common with many illuminators. Light emitted from the phosphor 554 is then collimated and filtered with a reflecting dichroic filter 558. Reflected light can then be incident again on the phosphor 554 and absorbed. Exciting the phosphor 554 in this manner can lead to subsequent emission of light of a different wavelength which can be transmitted through the filter 558 and add to the overall emission. This light recirculation acts to transform shorter wavelength (e.g., around 450 nm) into longer wavelength light (e.g., around 580 nm), favoring a component design with the longer-pass filters with narrow-band emitters. Where broad-band emitters are used, a comb filter with several pass bands in the visible spectrum may be used.

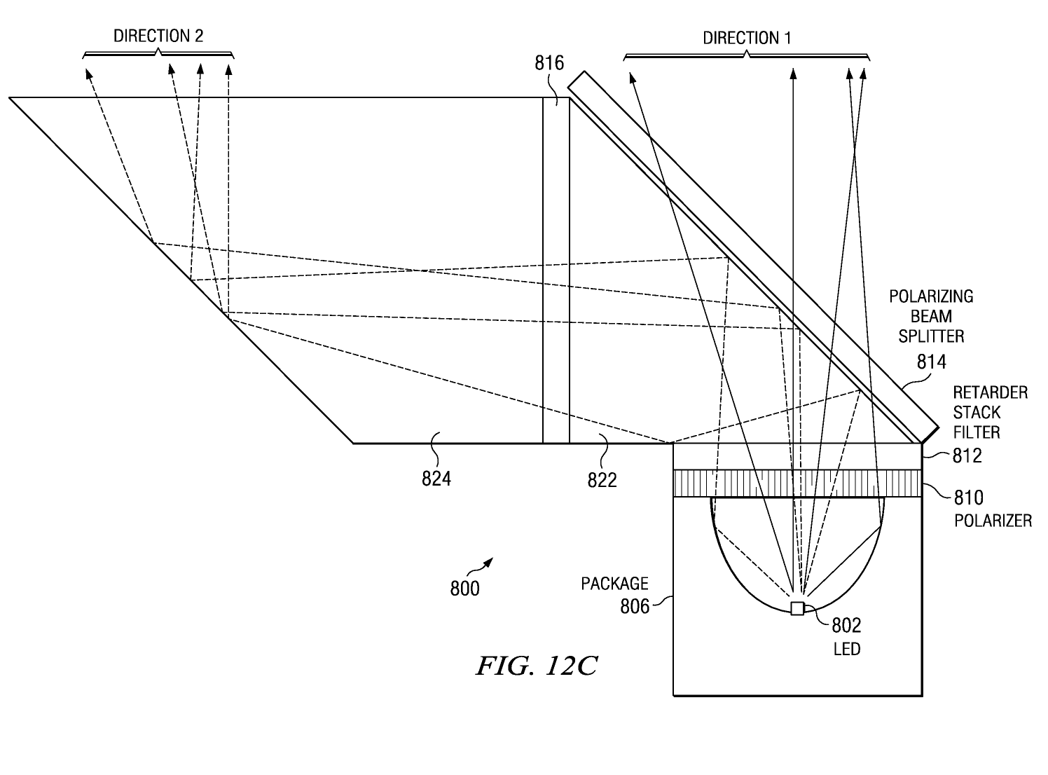

FIGS. 11A and 11B are schematic diagrams illustrating an embodiment of a light source 550 for a visual display backlight in which a spectral filter 608, be it dichroic or retarder stack based, may be mechanically removed from above the LED 602. Mechanical removal may be provided by any actuator known in the art that provides a sufficient lateral movement to position the spectral filter in the light path and outside the output light path of LED 602. In a first mode, illustrated by FIG. 11A, spectral filter 608 is in the output light path of LED, therefore allowing a predetermined spectral set (e.g., R1G1B1) to pass. In a second mode, illustrated by FIG. 11B, spectral filter 608 is not in the output light path of LED, therefore allowing all output light from the LED 602 to pass. The small size of some common RGB LED emitter packages 606 being around 3×3 mm makes this approach feasible. In an exemplary embodiment, using arrays of light sources, all spectral filters 608 could be attached to a single film or sheet 620 for global mechanical manipulation. Thus, the two modes shown by FIGS. 11A and 1B show how an LED backlight may be realized where spectral filtering, and its associated light loss, would not detract from standard use when the spectral filter is removed.

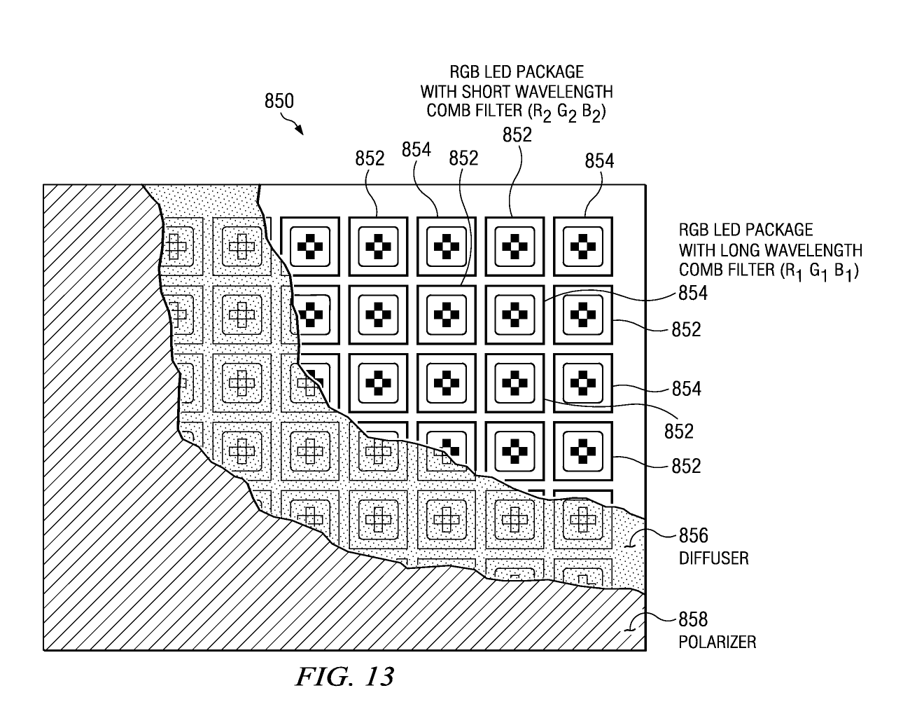

FIGS. 12A and 12B are schematic diagrams illustrating two different embodiments of a light source 700, 750 for a visual display backlight. The embodiment shown in FIG. 12A uses dichroic filters, and the embodiment shown in FIG. 12B uses retarder stack filters, where complementary spectral light is deflected rather than discarded. Directing this deflected light in such a way as to emit separate complementary spectral light (second spectral light, such as R2G2B2) from directly emitted light (first spectral light, such as R1G1B1) enables use of all light in a scrolling or spatially-separate illumination scheme. In the dichroic case shown by FIG. 12A, a dichroic filter 700 is placed at angle with respect to the light emission from LED 702 in order to deflect light of the second spectral set. In the retarder stack embodiment shown by FIG. 12B, a reflecting polarizing beam splitter 764 such as a wire grid, DBEF film, or MacNeille prism is used, and a polarization rotator 766 may be implemented to provide a more uniform polarization of both direct and indirect beams.

FIG. 12C is a schematic diagram of a light source 800 for a visual display backlight, illustrating how the embodiment of FIG. 12B may be modified by adding non-imaging wave guiding optics 822, 824 to laterally displace the beam. Examples of non-imaging optical wave guides may include light pipes, light tunnels, and compound parabolic concentrators. An example application of panel illumination using such techniques is shown below.

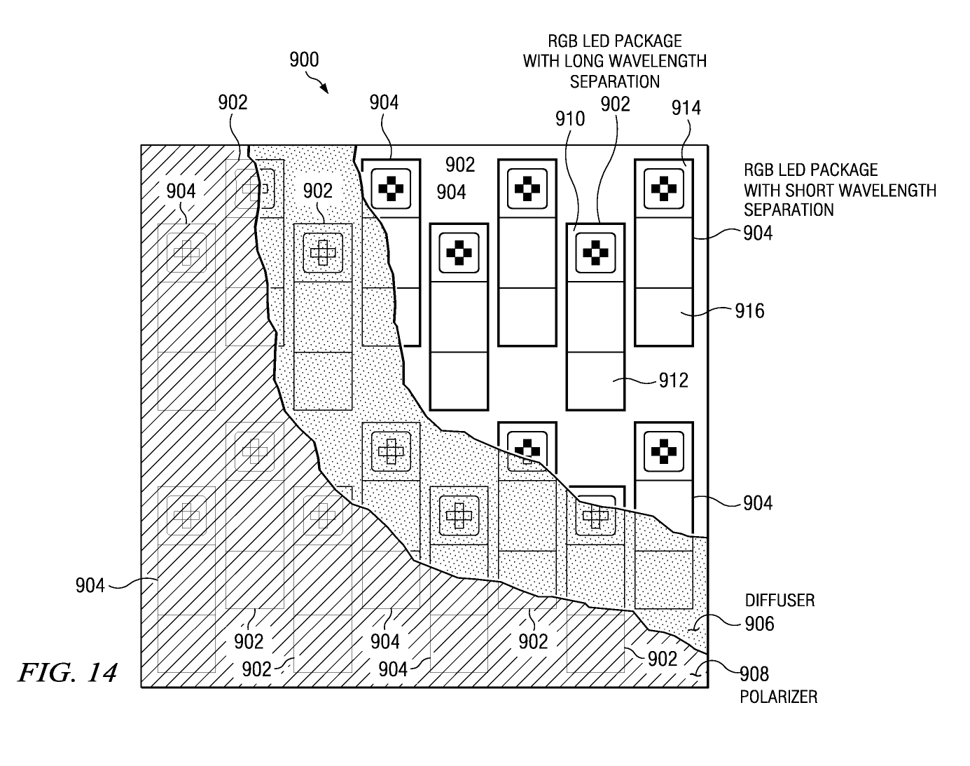

FIG. 13 is a schematic diagram illustrating a system 850 in which an array of light sources 852, 854 can be used to provide a backlight to illuminate an LCD panel. Here, RGB light sources 852, 854 may be filtered with spectral filters, each having three pass bands. As discussed above, a first spectral set may have R1G1B1 passbands, and a second spectral set may have R2G2B2 passbands. As discussed, the spectral filters may be retarder stack or dichroic-based. Thus, as arranged in this embodiment, light sources 852 and 854 are arranged in an alternating (checker board) type configuration to provide alternating R1G1B1 and R2G2B2 spectral emissions.

In other embodiments, the light sources may be of the switched type (e.g., embodiments shown in FIGS. 5A, 5B & 6), or a mechanical means (e.g., as shown in FIGS. 11A & 11B). A polarization-preserving diffuser 856 may be used with retarder stack-based embodiments prior to the input polarizer 858 of the LCD.

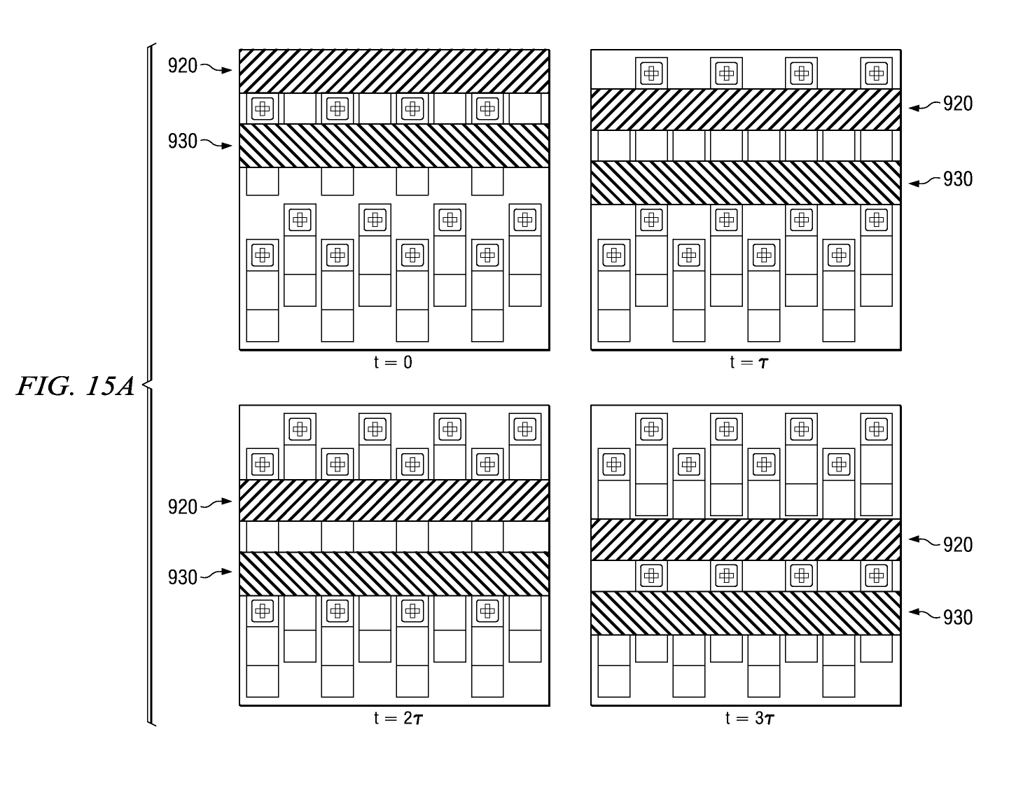

FIG. 14 is a schematic diagram illustrating a system 900 in which an array of light sources 852, 854 may be used to provide a backlight to illuminate an LCD panel. Light sources 902, 904 may have similar structure to the embodiments described with reference to FIGS. 12A-C, using appropriate non-imaging waveguide optics to guide light. Light sources 902 may provide a first set of spectral bands (e.g., R1G1B1) from a first output port 910, and a complementary second set of spectral bands from a second output port 912. Similarly, light sources 904 may provide a second set of spectral bands (e.g., R2G2B2) from a first output port 914, and a complementary first set of spectral bands from a second output port 916. A polarization-preserving diffuser 906 may be used with retarder stack-based embodiments prior to the input polarizer 908 of the LCD. Such a configuration reduces the number of LEDs in a backlight, saving power and reducing heat output.

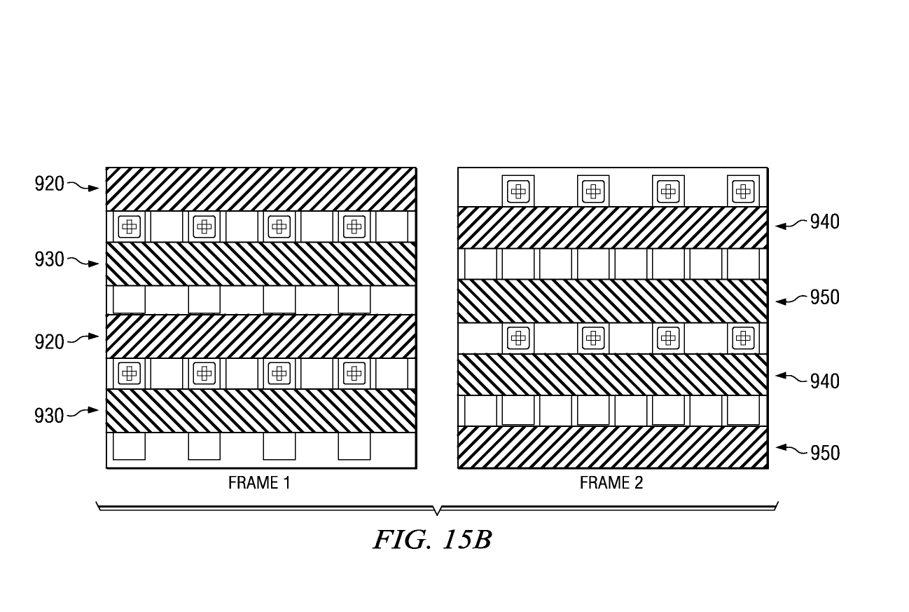

FIGS. 15A and 15B are schematic diagrams illustrating spatially-separated filtering approaches incorporated into a scrolling LCD backlight. Referring to FIG. 15A—which shows the embodiment of FIG. 14 in operation—successive illumination of light sources 902, 904 can produce color bands of a first and second spectral sets that may illuminate pixels on an LCD containing color-specific image information. Such successive illumination is shown by the scrolling first and second spectral set of bands 920, 930 respectively. The addressed pixels, prior to being illuminated by a first spectral set of bands 920, may have modulation values specific to that color encoding. A second set of values may be sent to the same pixels, prior to illumination by the second spectral set of bands 930. Although this is a more complex technique for providing a scrolling scheme than those described in commonly-assigned U.S. Pat. App. Pub. No. 2007/0188711 A1, entitled “Multi-functional active matrix liquid crystal displays” filed Feb. 9, 2007 (herein incorporated by reference), the principles of scrolling are similar, in that scrolling acts to hide pixel settling time and reduce motion artifacts.

FIG. 15B shows another example of the embodiment of FIG. 14 in operation, but with more than one first set of spectral bands 920 and more than one second set of spectral bands 930 being illuminated at a time. In a first frame, the first set of spectral bands 920 may be illuminated and the second set of spectral bands 930 may also be illuminated. In a second frame, the second row of LEDs are turned on, providing illumination from the first set spectral bands 940 and the second set of spectral bands 950. The first and second frames may be alternated to provide a dual (or quad) scrolling scheme. Such a scheme may be used with a fast-response LCD to reduce artifacts and improve display performance.

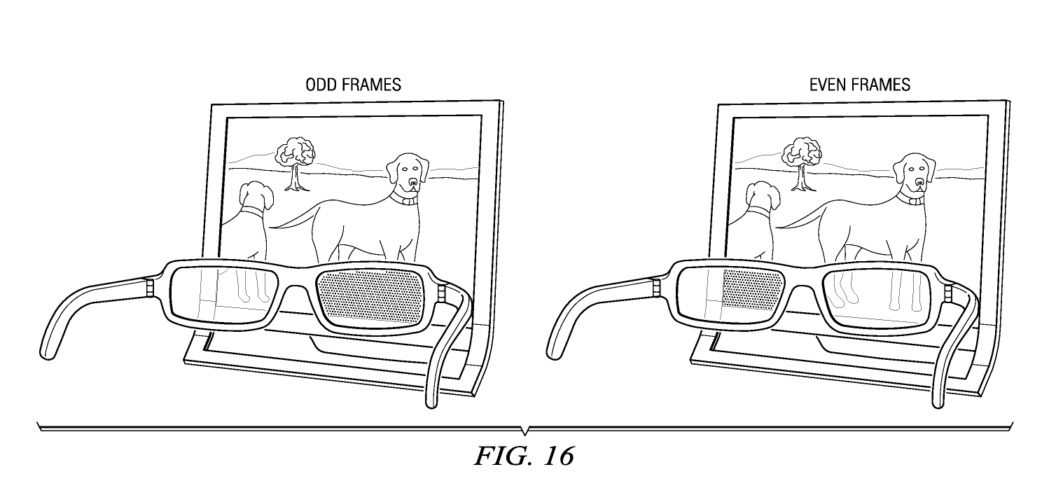

FIG. 16 shows an exemplary system embodiment where filtered LEDs are used to illuminate alternate frames of a display to allow stereoscopic viewing through appropriate color-selective eyewear, for example, as described in commonly-assigned pat. application Ser. No. 11/465,715, entitled “Stereoscopic eyewear,” filed Aug. 18, 2006, herein incorporated by reference. Exemplary embodiments using a pair of spectral sets for outputting left and right eye images are described in commonly-assigned U.S. Pat. App. Pub. No. 2007/0188711 A1, previously incorporated by reference.

While several embodiments and variations of polarization conversion systems for stereoscopic projection have been described above, it should be understood that they have been presented by way of example only, and not limitation. Thus, the breadth and scope of the invention(s) should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 CFR 1.77 or otherwise to provide organizational cues. These headings shall not limit or characterize the invention(s) set out in any claims that may issue from this disclosure. Specifically and by way of example, although the headings refer to a “Technical Field,” such claims should not be limited by the language chosen under this heading to describe the so-called technical field. Further, a description of a technology in the “Background” is not to be construed as an admission that technology is prior art to any invention(s) in this disclosure. Neither is the “Brief Summary” to be considered as a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings set forth herein.

What is claimed is:

1. A light source for a visual display system comprising:
a light emitting diode (LED);
a package having a depression in which the LED is housed; and
a spectral filter operable to filter light output from the LED, comprising:
an input polarizing element;
an output polarizing element; and
a retarder stack between the input polarizing element and the output polarizing element.

2. The light source of claim 1, wherein the retarder stack is operable to transmit a first set of spectral bands with a first polarization state, is operable to transform a second set of spectral bands to a second polarization state, and wherein the first and second polarization states are orthogonal.

3. The light source of claim 2, wherein the first and second sets of spectral bands each comprise first, second and third passbands.

4. The light source of claim 2, wherein the first and second sets of spectral bands comprise three pairs of passbands, the first passband in each pair being substantially non-overlapping in frequency range with the second passband in the pair.

5. The light source of claim 1, wherein the spectral filter is operable to transmit a first set of spectral emissions and block a second set of spectral emissions.

6. The light source of claim 1, wherein the input polarizing element comprises a reflecting polarizer.

7. The light source of claim 6, further comprising a quarter wave retarder located in a light path between the LED and the input polarizing element.

8. The light source of claim 1, wherein the input polarizing element comprises an absorptive polarizer.

9. The light source of claim 1, wherein a single color LED is housed in the package.

10. The light source of claim 9, wherein the light source further comprises a phosphor.

11. The light source of claim 1, wherein the package houses at least two selected from the group consisting of a red LED, a blue LED and a green LED.

12. The light source of claim 1, wherein the package houses a red LED, a blue LED and two green LEDs.

13. The light source of claim 1, wherein the retarder stack comprises N≧2 retarder films, wherein the input polarizing element, the retarder stack, and the output polarizing element are collectively designed to comprise a Finite Infinite Response (FIR) filter, and thereby are operable to generate at least N+1 spatially offset light pulses in response to a linearly polarized light impulse input, the FIR filter operable to substantially filter at least one band of light.

14. The light source of claim 6, wherein the spectral filter further comprises
a liquid crystal (LC) switch,
wherein the LC switch is between the input polarizing element and the retarder stack.

15. The light source of claim 14, wherein the spectral filter is operable in a first state to allow a first set of spectral bands to pass and to block a second set of spectral bands; and wherein the spectral filter is operable in a second state to allow the second set of spectral bands to pass and to block the first set of spectral bands.

16. The light source of claim 6, wherein the spectral filter further comprises:
a second retarder stack, and
a liquid crystal (LC) switch,
wherein the retarder stack is between the LC switch and the input polarizing element, and wherein the second retarder stack is between the output polarizing element and the LC switch.

17. The light source of claim 16, wherein the spectral filter is operable in a first state to allow a first set of spectral bands to pass and to block a second set of spectral bands; and wherein the spectral filter is operable in a second state to allow the first and second set of spectral bands to pass.

18. A light source for a visual display system comprising:
a light emitting diode (LED);
a package having a depression in which the LED is housed; and and
a spectral filter operable to transmit a first set of spectral bands and block a second set of spectral bands.

19. The light source of claim 18, wherein the first and second sets of spectral bands each comprise first, second and third passbands.

20. The light source of claim 18, wherein the first and second sets of spectral bands comprise three pairs of passbands, the first passband in each pair being substantially non-overlapping in frequency range with the second passband in the pair.

21. The light source of claim 18, wherein the spectral filter is a dichroic filter.

22. The light source of claim 18, wherein the spectral filter comprises:
a input polarizing element;
a output polarizing element; and
a retarder stack located between the first and output polarizing elements.

23. A backlight for a Liquid Crystal Display, comprising:
a substrate; and
a first light source and a second light source mounted on the substrate, each light source comprising:
a light emitting diode (LED),
a package having a depression in which the LED is housed, and
a spectral filter,
wherein the spectral filter of the first light source is operable to transmit a first set of spectral bands and block a second set of spectral bands, and
wherein the spectral filter of the second light source is operable to transmit the second set of spectral bands and block the first set of spectral bands.

24. The light source of claim 23, wherein the first and second sets of spectral bands comprise three pairs of passbands, the first passband in each pair being substantially non-overlapping in frequency range with the second passband in the pair.

25. The light source of claim 23, wherein the spectral filter comprises:
a input polarizing element;
a output polarizing element; and
a retarder stack located between the first and output polarizing elements.
